(19) United States
(12) Patent Application Publication
(10) Pub. No.: US 2012/0068499 A1
(43) Pub. Date: Mar. 22, 2012

(54) FRAME STRUCTURE FOR THE BODY FLOOR OF A MOTOR VEHICLE, FLOOR UNIT, UNDERBODY AND VEHICLE BODY

(75) Inventors: Udo MILDNER, Limburg (DE); Stanislaw KLIMEK, Frankfurt/Main (DE)

(73) Assignee: GM GLOBAL TECHNOLOGY OPERATIONS LLC., Detroit, MI (US)

(21) Appl. No.: 13/233,749

(22) Filed: Sep. 15, 2011

(30) Foreign Application Priority Data
Sep. 16, 2010 (DE) 102010045586.5

(51) Int. Cl. B62D 25/20

(52) U.S. Cl. 296/193.07; 296/204

(57) ABSTRACT

A frame structure is provided for the body floor of a motor vehicle, particularly of a motor vehicle with occupants seated up high, as for example off-road sedan, off-road car or van. It is provided that the frame structure is designed in the manner of a ladder frame. A floor unit is provided and an underbody for a vehicle body. Furthermore, the a motor vehicle is provided, particularly the vehicle body of a motor vehicle.

### CROSS-REFERENCE TO RELATED APPLICATION

This application claims priority to German Patent Application No. 102010045586.5, filed Sep. 16, 2010, which is incorporated herein by reference in its entirety.

### TECHNICAL FIELD

The technical field relates to a frame structure for the body floor of a motor vehicle, particularly of a motor vehicle with occupants seated high up such as for example off-road sedan, off-road vehicle or van. The technical field furthermore relates to a floor unit and an underbody for a vehicle body, and a motor vehicle, particularly the vehicle body of a motor vehicle.

### BACKGROUND

Modern motor vehicles usually have a frame structure in the region of the body floor, which serves for the stiffening of the body. A body with a high structural stiffness is aspired to in order to offer the best possible protection for the vehicle occupants in the event of a crash. However, in recent years the requirements on the body structure with respect to the crash behavior, the torsional stiffness and the fatigue durability have been steadily rising. This has to be taken into account in the further development of the vehicles.

Therefore, at least one object is further development of a frame structure for the body floor of a motor vehicle with the features mentioned at the outset such that an improved structural stiffness of the vehicle body is achieved. Furthermore, at least another object is a floor unit and an underbody for a vehicle body and a vehicle body with a frame structure improved to that effect. In addition, other objects, desirable features and characteristics will become apparent from the subsequent summary and detailed description, and the appended claims, taken in conjunction with the accompanying drawings and this background.

### SUMMARY

A frame structure for the body floor of a motor vehicle is proposed, a floor unit for a vehicle body, an underbody for a vehicle body and a motor vehicle, particularly a vehicle body of a motor vehicle, are proposed. A frame structure is provided for the body floor of a motor vehicle, particularly of a motor vehicle with passengers seated high up such as for example off-road sedan, off-road car or van is among other things. The frame structure is designed in the manner of a ladder frame.

Because of this a frame structure is realized which is particularly sturdy and imparts a high structural stiffness to the body of a motor vehicle. The ladder frame structure is simple in design so that the frame structure can be realized in a simple manner. Because of the high stiffening effect of the ladder frame structure, reinforcing elements necessary up to now can be omitted without losses in the overall stiffness of the body relative to the previously existing state occurring. This in turn results in that because of the ladder frame structure the body of a motor vehicle can be built lighter in terms of weight than previously.

Preferably, the frame structure comprises at least two longitudinal profiles and a plurality of transverse profiles interconnecting the longitudinal profiles. The transverse profiles in this case are arranged substantially transversely to the longitudinal profiles. The longitudinal profiles and transverse profiles are thus arranged relative to each other in the manner of a ladder and form the ladder frame of the frame structure. Through the plurality of existing transverse profiles the frame structure has a particularly high stability, in particular, a vehicle body with high torsional stiffness and high stiffening reinforcement against a lateral impact can be realized as a result.

Because of the longitudinal shape of the ladder-type frame structure and the likewise longitudinal shape of the motor vehicle in the direction of its longitudinal axis the longitudinal profiles should extend in the direction of the vehicle longitudinal axis in the installed state of the frame structure in the vehicle body. It is appropriate that at least one of the transverse profiles is connected to the longitudinal profiles at the end portions located in longitudinal direction. Because of this, the ladder frame structure is imparted a particularly sturdy bond. In one embodiment, at least one of the transverse profiles with at least one of its longitudinal sides bears against the longitudinal profiles aims in the same direction.

Based on the installation state of the frame structure, the longitudinal profiles should lie under the transverse profiles. Through the longitudinal profiles being located below it is particularly appropriate, based on the installation state, to place or attach the frame structure on/to the body floor of the motor vehicle from above. Starting out from the body floor an upward structure is realized, through which possible seats and/or seat benches can be arranged elevated. The frame structure is therefore particularly suited for the purpose of being installed in a motor vehicle with occupants seated high up, such as for example an off-road sedan, an off-road car or van.

Preferably, at least one of the transverse profiles should be connected to the longitudinal profiles by means of thermal joining, particularly welding and/or by means of screwing means, in order to achieve a permanently durable connection between transverse profiles and the longitudinal profiles. In addition, for aligning the at least one transverse profile relative to the longitudinal profiles a centering protrusion can be provided, which engages in a mount. The centering protrusion is preferably arranged on the at least one transverse profile and the mount on the associated longitudinal profile. Through the centering protrusion and the corresponding mount the assembly of the at least one transverse profile on the associated longitudinal profile or the associated longitudinal profiles is substantially facilitated, since prior to the fixing, the transverse profile can be brought into a predetermined position relative to the longitudinal profile.

According to an embodiment it is provided that the longitudinal profiles, at least in the connecting region with the cross members, have a hollow profile closed in cross section, particularly polygonal profile. The longitudinal profiles can be designed as tubular profile, so that the longitudinal profiles substantially have a hollow profile closed in cross section over their longitudinal extension. It is conceivable that the polygonal profile is designed as quadrangular profile, particularly square or rectangular. A triangular, hexagonal or octagonal cross-sectional contour is also conceivable.

According to a further embodiment it is provided that at least one of the transverse profiles comprises a hollow profile, particularly polygonal profile at least in the connecting region with the side member or the side members. The at least one transverse profile can be designed as tubular profile so that in the direction of its longitudinal extension it continuously forms a closed hollow profile. The polygonal profile can be designed as quadrangle, particularly in square or rectangular shape. The polygonal profile can also be designed as triangle, hexagon or octagon.

According to an embodiment it can be provided that the longitudinal profiles have a substantially square cross section and at least one of the transverse profiles has a substantially rectangular cross section. According to another embodiment it is provided that at least one of the longitudinal profiles comprises at least one end portion, which is designed as support, particularly for the wheel housing or the front end of the body of the motor vehicle.

It is appropriate that the end portion is angled-off relative to the portion of the frame structure comprising the transverse profiles, particularly standing to the inside and/or based on the installation state of the frame structure stands upwards. Through the angled-off position the end portion is aligned in a position in which the end portion can particularly favorably act as support, in that the end portion can absorb and pass on forces substantially in the direction of its longitudinal axis. Because of its angled-off position, the end portion can be brought into such a position in the installed state of the frame structure that the end portion exercises a supporting function relative to the wheel housing. It is appropriate that the end portion is directed obliquely upwards.

In connection with the continuous horizontal wall of the lateral floor structure a triangular support element is obtained through the end portion, which in the event of a laterally offset front-end collision supports the front wheel and because of this reduces the penetration values and the risk of injury of the front passengers. In that the end portion is directed inwardly it can for example act on the front wheel bypassing the wheel housing and in the process act as support for the front frame. Because of this, the longitudinal profile can be run up to the motor vehicle bulkhead, as a result of which a further structural improvement upon a laterally offset front-end collision is achieved.

According to another it is provided that at least one of the transverse profiles is designed for receiving, fastening and/or aligning at least one seat or one seat bench. Because of this, the frame structure assumes a dual function, namely on the one hand the frame structure serves for the stiffening of the vehicle body, preferentially in the region of the body floor. On the other hand, the frame structure serves for the fastening for at least one seat of the vehicle. Additional elements for seat fastening can consequently be saved so that through the frame structure, a motor vehicle that is light with regard to weight can be realized. The at least one of the transverse profiles can comprise a mount for hooking-in a mating element of a seat or a seat bench. In addition, the at least one of the transverse profiles can be designed for a screwed fastening to the transverse profile. To this end, the transverse profile can have a through-bore or threaded bore for a screwed fastening.

It is also conceivable that at least one of the transverse profiles comprises at least one centering element or a centering contour, which corresponds to a mating centering element or a mating centering contour of the seat or of the seat bench and makes possible a position alignment of the seat or of the seat bench relative to the transverse profile. Through the alignment, the fixing of the seat or of the seat bench on the transverse profile is substantially facilitated. The centering contour on the transverse profile can be formed through forming of the transverse profile, for example through internal high-pressure forming. Through the centering contour on the transverse profile, positioning and thus a tolerance improvement for the seat attachment is ensured.

It is appropriate that at least one, preferentially two of the transverse profiles is designed for the fastening of at least one front seat. Here it is conceivable that one of the transverse profiles comprises a mount for hooking in the seat and the other of the transverse profiles for the fastening of the front seat has at least one means for fastening, particularly screw fixing of the front seat. It is furthermore conceivable that at least one, preferentially two of the transverse profiles is designed for the fastening of at least one seat of the second seat row.

A floor unit is also provided for a vehicle body with a floor structure and, on top of this, a frame structure of the type described above fixed particularly by means of welding. The floor unit is preferably pre-assembled and can be present as preassembled unit before it arrives at the final assembly of the vehicle body. Furthermore, an underbody is provided for a vehicle body, which comprises a front end, a front floor unit of the type described above and a rear floor unit. On the underbody, a lateral floor or a lateral floor structure can be additionally assembled on both sides. A motor vehicle, particularly the body of a motor vehicle, is provided with an underbody of the type described above.

In an independent and subsidiary embodiment, a method is provided for the assembly of a floor unit for a vehicle body. A frame structure, particularly a frame structure of the type described above, is assembled on the side of a body floor facing the passenger cell of a motor vehicle. The floor unit can be a floor unit of the type described above. Through this measure the frame structure is assembled on the floor unit from above, so that first an assembly of the vehicle floor is made possible and subsequently the frame structure can be assembled onto the vehicle floor from above.

### BRIEF DESCRIPTION OF THE DRAWINGS

The present invention will hereinafter be described in conjunction with the following drawing figures, wherein like numerals denote like elements, and:

FIG. 1 is a possible embodiment of a frame structure for the body floor of a motor vehicle in perspective representation;

FIG. 2 is the frame structure according to FIG. 1 in sectional representation along the section line A-A according to FIG. 1;

FIG. 3 is the frame structure according to FIG. 1 assembled to a front body floor in perspective representation;

FIG. 4 is an example for the assembly of the underbody of a vehicle body to a frame structure according to FIG. 1 in perspective representation;

FIG. 5 is an underbody for a vehicle body assembled from individual components having a frame structure according to FIG. 1 in perspective representation; and

FIG. 6 is the underbody according to FIG. 5 along the section line B-B according to FIG. 5.

### DETAILED DESCRIPTION

The following detailed description is merely exemplary in nature and is not intended to application and uses. Furthermore, there is no intention to be bound by any theory presented in the preceding background or summary or the following detailed description.

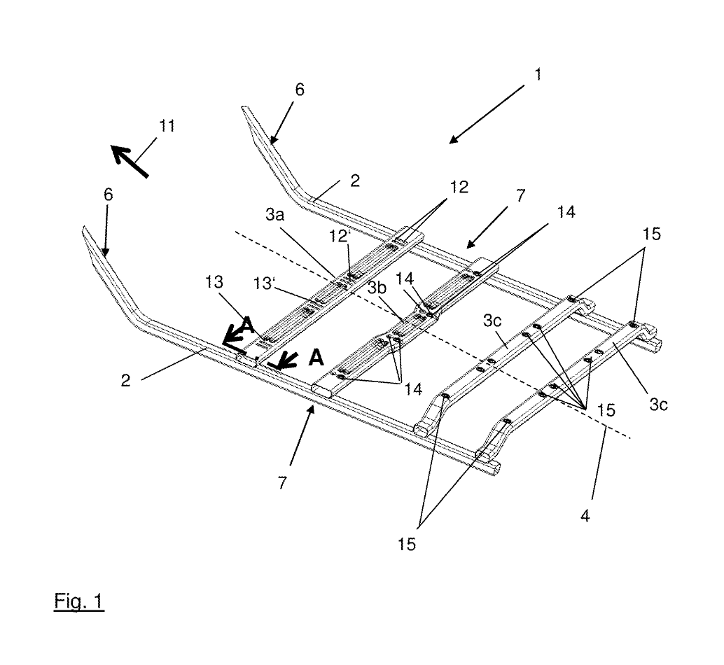

FIG. 1 shows, in schematic representation, a possible embodiment of a frame structure 1 for the body floor of a motor vehicle (not shown). The frame structure 1 is particularly suited for being installed in a motor vehicle with occupants seated up high. Such motor vehicles are, for example an off-road sedan, an off-road car or a van. As is evident from FIG. 1 the frame structure 1 has the shape of a ladder frame at least over a region.

The frame structure 1 comprises two longitudinal profiles 2 and a plurality of transverse profiles 3a, 3b, 3c interconnecting the longitudinal profiles 2. The frame structure 1 in this case is aligned in the manner that the longitudinal profiles 2 with their longitudinal extension lie in the direction of the vehicle longitudinal axis 4.

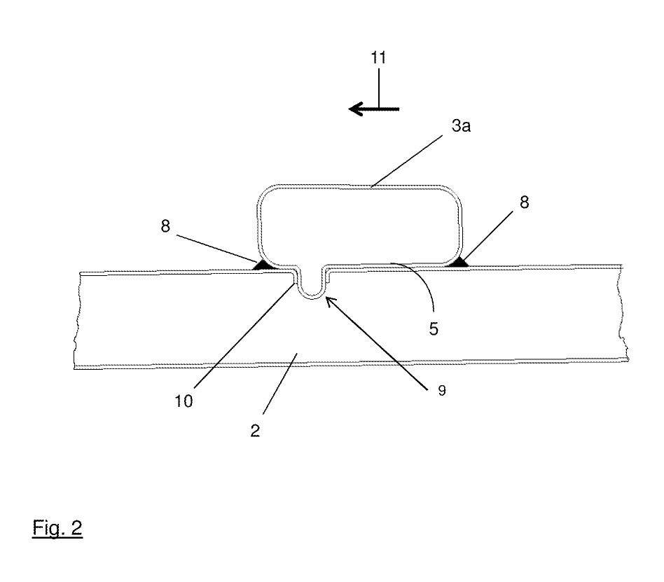

The ladder frame structure is particularly formed in that the transverse profiles 3a, 3b, 3c at their respective end portions located in longitudinal direction bear against the longitudinal profiles 2, more preferably are connected to these. The transverse profiles 3a, 3b and 3c in this case bear against the longitudinal profiles 2 with one of their longitudinal sides 5. As is particularly evident from FIG. 2 by means of the transverse profile 3a shown in sectional representation there, the transverse profiles 3a, 3b and 3c are designed, at least in the connecting region with the longitudinal profiles 2, as hollow profile closed in cross section in each case. Here, the hollow profile is designed quadrangular in cross section, particularly as rectangle.

The transverse profile 3a as well as the transverse profiles 3b and 3c are preferably connected to the longitudinal profiles 2 by means of a welded connection 8, particularly a weld seam. The transverse profile 3a furthermore comprises a protrusion 9, which serves for the centering and interacts with a mount 10 corresponding to the protrusion 9. By inserting the protrusion 9 in the mount 10 the transverse profile 3a is held in a predetermined position even before applying the welded connection 8 to the longitudinal profile 2, so that the welding of the transverse profile 3a to the longitudinal profile 2 can then be carried out in a simple manner without position shifting of the transverse profile 3a relative to the side member 2. Preferably, such a mount 10 is formed on both side members 2 and the cross member 3a has such a protrusion 9 on both its portions bearing against the side members 2.

The protrusion 9 can be formed through forming, particularly stamping, bending, roll forming or internal high-pressure forming. The mount 10 is preferably formed through an opening which passes through a side of the longitudinal profile 2 corresponding to the transverse profile 3a. The mount 10 can be formed through forming, particularly piercing or the like, so that the wall portions of the mount 10 facing to the inside form a guide for the protrusion 9 for centering the transverse profile 3a relative to the side member 2.

As is particularly evident from FIG. 1, the transverse profiles 3a, 3b and 3c are designed for receiving, fastening and/or aligning at least one seat (not shown) or a seat bench (not shown). To this end, the transverse profiles 3a and 3b are designed that at least one front seat (not shown) can be fastened thereto. Preferably, to this end, the transverse profile 3a, which preferentially forms the front-most transverse profile seen in driving direction 11, comprises at least one mount 12 for hooking-in a front seat (not shown). Preferably, on the transverse profile 3a for the attachment of a front seat (not shown), two mounts 12, 12′ arranged spaced relative to each other for hooking-in a front seat (not shown) are provided.

Preferably, the transverse profile 3a has at least one additional mount 13 and at least one additional mount 13′ for hooking-in a second front seat on the transverse profile 3a. Preferably, the transverse profile 3b, which seen in driving direction 11 is arranged in front of the transverse profile 3a, comprises means 14 for a screwed fastening of the front seat (not shown). The two transverse profiles 3c shown in the FIG. 1 are preferentially designed in the same manner and serve for being able to assemble thereon a second seat row (not shown). To this end, the transverse profiles 3c each comprise a plurality of means 15 for a fastening of the second seat row (not shown), particularly for a screwed fastening.

As is furthermore evident from FIG. 1, the longitudinal profiles 2 have a free end portion 6 which is formed on the seen in driving direction 11 rear end of the longitudinal profiles 2 and in the installed state of the frame structure 1 faces in the direction of the front of the motor vehicle (not shown). The end portions 6 of the longitudinal profiles 2 in this case are arranged at an angle above the portion 7 comprising the transverse profiles 3a, 3b and 3c.

In the alignment of the frame structure 1 shown in FIG. 1, which corresponds to the alignment in the installed state in the vehicle body (not shown), the end portions 6 run obliquely upwards in driving direction 11. Because of this, the longitudinal profiles 2 are utilized as supports in the region of their end portion 6 which can serve for supporting the wheel housing (not shown in FIG. 1) or the front frame (not shown in FIG. 1) of a vehicle body.

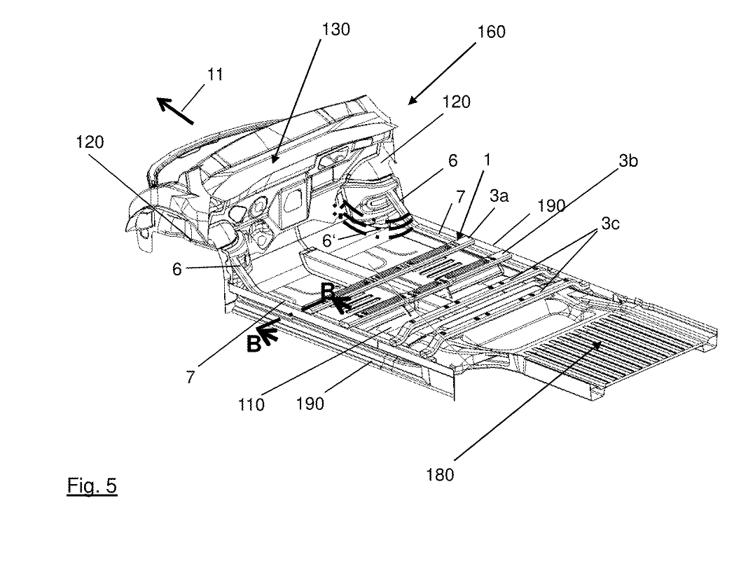

The possible supporting effect of the longitudinal profiles 2 through their end portions 6 is evident on the example of FIG. 5. FIG. 5 shows an underbody 160 for a vehicle body. The underbody 160 among other things comprises the frame structure 1, wherein the end portions 6 of the longitudinal profiles 2 with their end support themselves against the wheel housing 120 of each vehicle side.

By means of the dash hyphen dotted lines drawn in FIG. 5 an alternative embodiment of the end portion of the respective longitudinal profile 2 is drawn in, which is provided there with the reference number 6′. The end portion 6′ in this case is angled-off to the inside relative to the portion 7 of the longitudinal profile 2 and preferentially runs arc-like into the front region of the underbody 160 bypassing the wheel housing 120 and with its end acts on the front frame 130, so that the respective longitudinal profile 2 supports itself against the front frame 130 with its end portion 6′.

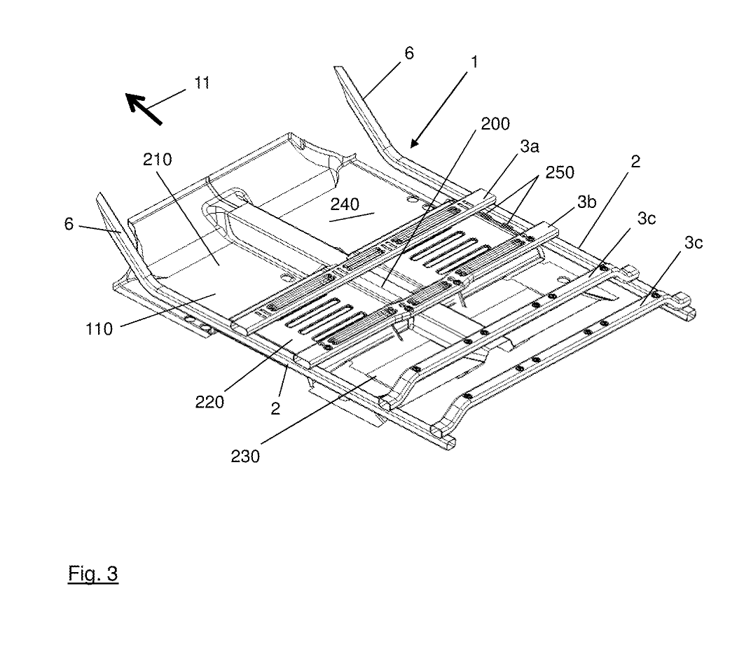

FIG. 3 shows the frame structure 1 according to FIG. 1 assembled to a body floor 110, which preferably is the front body floor of the vehicle body. The body floor 110 has a center tunnel 200, which seen in driving direction 11 substantially extends over the entire body floor 110. The body floor 110 comprises a front portion 210, a middle portion 220 and a rear portion 230, which are arranged horizontally one after the other in driving direction 11.

As is evident from FIG. 3, the frame structure 1 is arranged on the top 240 of the body floor 110. The top 240 in this case is that side of the body floor 110 which faces the passenger compartment (not shown) of the motor vehicle. By attaching the frame structure 1 to the top of the body floor 110 the frame structure 2, particularly its transverse profiles 3a, 3b and 3c is particularly well suited in order to be able to fasten seats of the vehicle (not shown) thereon. Insofar the frame structure 1 assumes a dual function, namely on the one hand acting as stiffening for the vehicle body and on the other hand for serving as seat fastening for the vehicle seats. The frame structure 1 is preferably connected to the body floor 110 in a fixed manner by means of at least one, preferentially a plurality of welded connections 250.

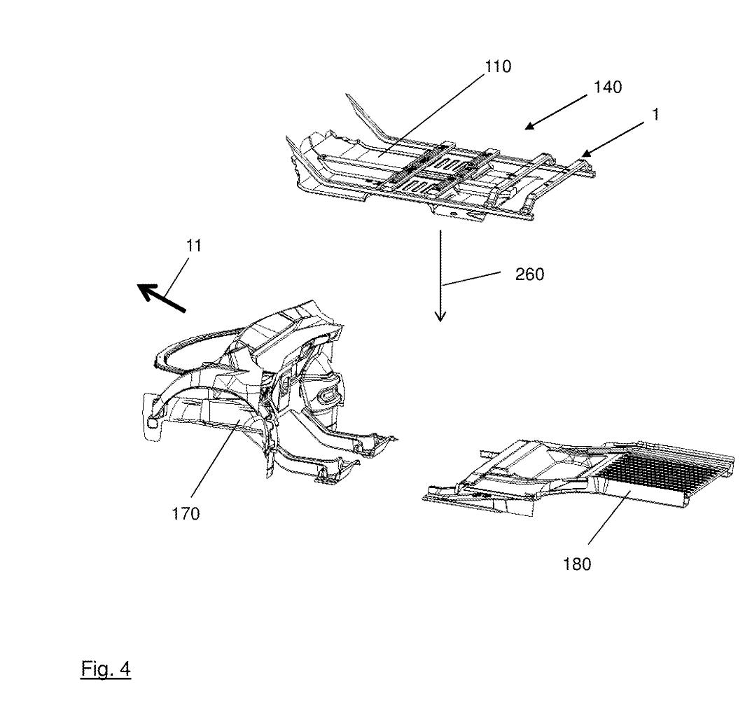

FIG. 4 shows a possible sequence during the assembly of the underbody 160 of a vehicle body as is evident from FIG. 5. A front end 170 and a rear underbody or a rear floor unit 180 is assembled separately from each other. During the course of the further assembly of the vehicle body, the front end 170 and the rear floor unit 180 are laid out spaced from each other and then in a further assembly step through inserting a floor unit 140, preferentially introduced from the top into the intermediate space between front end 170 and rear floor unit 180 and connected to the front end 170 and the rear floor unit 180. The floor unit 140 in this case is preferably brought into the final assembly position in joining direction according to the arrow 260. The floor unit 140 in this case is the frame structure 1, which is mounted in a fixed manner to the body floor 110 according to FIG. 3.

Following the joining of the floor unit 140 to the front end 170 and the rear floor unit 180, the lateral floor structure 190 is connected to the body floor 110 and the longitudinal profiles 2, particularly by means of welding or screwing. Because of this, a structural bond is altogether realized which improves the torsional stiffness of the entire vehicle body and upon a lateral impact of the vehicle reduces the penetration values and thus increases the survival space for the vehicle occupants. The ready-assembled underbody 160 is shown in FIG. 5. The end portion 6 shown in FIG. 5 of each longitudinal profile 2 is preferably connected in the underbody 160 to the horizontal wall of the lateral floor structure 190, so that a triangular support element is obtained. This triangular support element supports the front wheel in the event of a laterally offset front-end collision and because of this reduces the penetration values and the risk of injury of the front vehicle occupants.

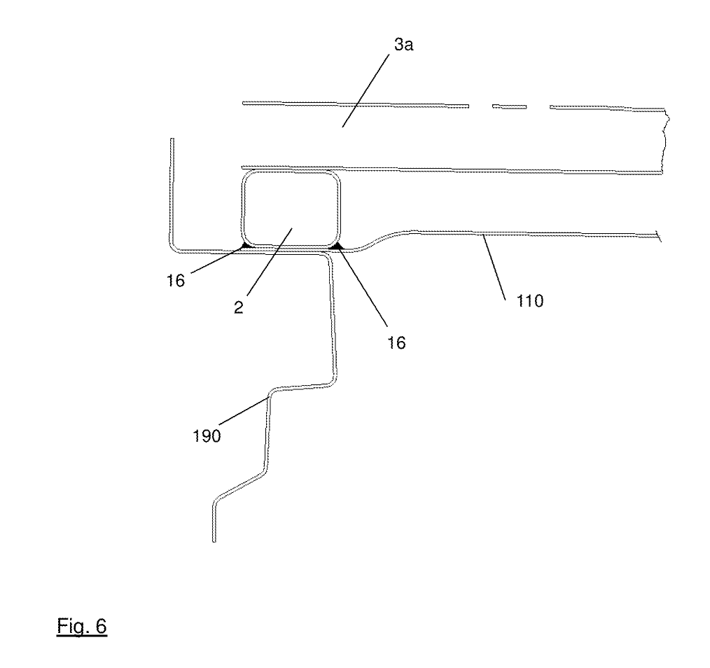

The alternative embodiment of the end portion 6′ of the respective longitudinal profile 2 shown through the dash hyphen dotted lines is an improved version, since the end portion 6′ is run up to the connection of the front frame 130 to the motor vehicle bulkhead. Because of this, a structural improvement can be achieved in the event of a laterally offset front-end collision. FIG. 6 shows the underbody 160 of FIG. 5 along the section line B-B. As is evident from this, the side members 2 are connected to the body floor 110 by means of a welded connection 16. The body floor 110 in turn is placed onto a horizontal side wall of the lateral floor structure 190 and preferentially fixed thereon.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A frame structure for a body floor of a motor vehicle, comprising:
a first longitudinal profile;
a second longitudinal profile; and
a plurality of transverse profiles interconnecting the first longitudinal profile and the second longitudinal profile to form a ladder frame.

2. A frame structure according to claim 1, wherein the motor vehicle is and off-road vehicle.

3. A frame structure according to claim 1, wherein the motor vehicle is a van.

4. The frame structure according to claim 1, wherein at least one of the plurality of transverse profiles is connected to the first longitudinal profile and the second longitudinal profile with end portions lying in a longitudinal direction.

5. The frame structure according to claim 1, wherein at least one of the plurality of transverse profiles is configured to bear against the first longitudinal profile and the second longitudinal profile with a longitudinal side.

6. The frame structure according to claim 1, wherein based on an installation state, the first longitudinal profile and the second longitudinal profile are configured to lie under the plurality of transverse profiles.

7. The frame structure according to claim 1, wherein based on an installation state, the frame structure is placed against the body floor of the motor vehicle from above.

8. The frame structure according to claim 1, wherein the first longitudinal profile and the second longitudinal profile comprise a hollow profile closed in cross section at least in connecting regions with the plurality of transverse profiles.

9. The frame structure according to claim 8, wherein the hollow profile closed in cross section is a polygonal profile.

10. The frame structure according to claim 1, wherein at least one of the plurality of transverse profiles in at least connecting regions with the first longitudinal profile and the second longitudinal profile comprises a hollow profile closed in cross section.

11. The frame structure according to claim 1, wherein the first longitudinal profile comprises a portion configured to support, a component of a front frame.

12. The frame structure according to claim 11, wherein an end portion is angled off relative to the portion of the frame structure comprising the plurality of transverse profiles.

13. The frame structure according to claim 1, wherein at least one of the plurality of transverse profiles is configured to receive a seat.

14. A floor unit for a body of a motor vehicle, comprising:
a body floor; and
a frame structure for the body floor, the frame structure comprising:
a first longitudinal profile;
a second longitudinal profile; and
a plurality of transverse profiles interconnecting the first longitudinal profile and the second longitudinal profile to form a ladder frame.

15. The floor unit according to claim 14, wherein the motor vehicle is an off-road vehicle.

16. The floor unit according to claim 14, wherein the motor vehicle is a van.

17. The floor unit according to claim 14, wherein at least one of the plurality of transverse profiles is connected to the first longitudinal profile and the second longitudinal profile with end portions lying in a longitudinal direction.

18. The floor unit according to claim 14, wherein at least one of the plurality of transverse profiles is configured to bear against the first longitudinal profile and the second longitudinal profile with a longitudinal side.
